(19) United States
(12) Patent Application Publication
(10) Pub. No.: US 2026/0261951 A1
(43) Pub. Date: Sep. 3, 2026

(54) METHODS AND APPARATUSES FOR RECEIVING AND TRANSMITTING INDICATION INFORMATION AND COMMUNICATION SYSTEM

(71) Applicant: 1FINITY Inc., Kawasaki-shi (JP)

(72) Inventors: Jing ZHU, Beijing (CN); Huiting CHENG, Yokohama (JP)

(73) Assignee: 1FINITY Inc., Kawasaki-shi (JP)

(21) Appl. No.: 19/659,157

(22) Filed: Apr. 27, 2026

Related U.S. Application Data
(63) Continuation of application No. PCT/CN2023/129607, filed on Nov. 3, 2023.

(51) Int. Cl. H04W 36/36; H04W 36/00; H04W 72/232; H04W 76/28

(52) U.S. Cl. CPC H04W 36/362; H04W 36/0058; H04W 72/232; H04W 76/28

(57) ABSTRACT

Methods and apparatuses for receiving and transmitting indication information and a communication system. The apparatus for receiving indication information is applicable to a terminal equipment and includes a first processor, the first processor controlling the terminal equipment to perform the following operations: receiving a first configuration from a network device, the first configuration being used for configuring a conditional handover; receiving first downlink control information (DCI) from the network device in a first serving cell, the first DCI comprising first information and/or second information, wherein the first information is used to indicate dormancy or shutdown information related to A serving cell of the terminal equipment, and the second information is used to activate or deactivate cell discontinuous transmission or reception of B serving cell of the terminal equipment; where, A and B are positive integers; and performing an operation related to the conditional handover.

### CROSS-REFERENCE TO RELATED APPLICATION

This application is a continuation application under 35 U.S.C. 111 (a) of International Patent Application PCT/CN2023/129607 filed on Nov. 3, 2023, and designated the U.S., the entire contents of which are incorporated herein by reference.

### TECHNICAL FIELD

This disclosure relates to the field of communication technologies.

### BACKGROUND

As an important component of global new infrastructure construction, the fifth generation (5G) communication network has experienced rapid development worldwide in recent years. The larger the network scale, the higher the energy consumption of operators. Taking the data released by the Chinese Ministry of Industry and Information Technology as an example, the energy consumption growth in 2022 will reach about 80% compared to 2015. With the construction of 5G, Active Antenna Units (AAUs) have been widely commercialized. Compared with the Remote Radio Units (RRUs) used in 3G and 4G, AAUs have higher power consumption, so the energy consumption of 5G devices will also increase exponentially. 5G has defined three major business types: Enhanced Mobile Broadband (eMBB), Massive Machine Type of Communication (mMTC), and Ultra Reliable Low Latency Communication (URLLC). This has led to an increasing number of 5G small packet burst services, with base stations operating 24 hours a day without interruption. The daily energy consumption of 5G sites will also be more than twice that of 4G.

3GPP has introduced key technologies such as Massive MIMO and larger RF bandwidth in the 5G era. 5G supports higher data rates and larger data traffic, requiring more transmission bandwidth. High frequency deployment will also be the main frequency band for future expansion of 5G. The high-frequency transmission characteristics limit the coverage range of the sites, resulting in denser deployment of 5G sites, and increasing the energy consumption of the sites will bring huge operating cost pressure to operators. Therefore, network energy conservation is of great significance for saving operating costs, and 5G network energy conservation is an urgent problem to be solved.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY OF THE DISCLOSURE

In order to achieve energy conservation, a network device can perform energy-saving processing in the time domain, frequency domain, spatial domain, and/or energy domain according to the network load situation. For example, in the time domain, the network device can introduce cell discontinuous transmission/reception technology, in which by configuring a cell active period and non-active (inactive) period in the network device, the network device transmits and receives signals only during the active period, while restricting signal transmission and reception during the inactive period, thereby achieving a purpose of network energy saving. Additionally, the network device may also introduce cell dormancy or cell shutdown techniques to achieve energy saving by stopping transmission and reception of all signals.

It was found by the inventors of this disclosure that how to flexibly and efficiently notify terminal equipments of information related to network energy saving has become a key problem needing to be solved.

In order to solve at least one of the above problems or other similar problems, embodiments of this disclosure provide methods and apparatuses for receiving and transmitting indication information and a communication system. In the method for receiving indication information, a terminal equipment receives first downlink control information (DCI) related to network energy saving from a network device, hence, information related to network energy saving may be flexibly and efficiently notified to the terminal equipment.

According to one aspect of the embodiments of this disclosure, there is provided an apparatus for receiving indication information, applicable to a terminal equipment, the apparatus including a first processor, the first processor controlling the terminal equipment to perform the following operations:
receiving a first configuration from a network device, the first configuration being used for configuring conditional handover;
receiving first downlink control information (DCI) from the network device in a first serving cell, the first DCI comprising first information and/or second information, wherein the first information is used to indicate dormancy or shutdown information related to A serving cell of the terminal equipment, and the second information is used to activate or deactivate cell discontinuous transmission or reception (Cell DTX/DRX) of B serving cell of the terminal equipment; where, A and B are positive integers; and
performing an operations related to the conditional handover.

According to another aspect of the embodiments of this disclosure, there is provided an apparatus for transmitting indication information, applicable to a network device, the apparatus comprising a second processor, the second processor controlling the terminal equipment to perform the following operations:
transmitting a first configuration to a terminal equipment, the first configuration being used for configuring conditional handover;
transmitting first downlink control information (DCI) to the terminal equipment in a first serving cell, the first DCI including first information and/or second information, wherein the first information is used to indicate dormancy or shutdown information related to A serving cell of the terminal equipment, and the second information is used to activate or deactivate cell discontinuous transmission or reception (Cell DTX/DRX) of B serving cell of the terminal equipment; where, A and B are positive integers.

An advantage of the embodiments of this disclosure exists in that the terminal equipment receives the first downlink control information (DCI) related to network energy saving from the network device, hence, information related to network energy saving may be flexibly and efficiently notified to the terminal equipment.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of a cell DTX/DRX operation;

FIG. 3 is a schematic diagram of a method for receiving indication information of an embodiment a first aspect of this disclosure;

FIG. 4 is a schematic diagram of first DCI;

FIG. 5 is another schematic diagram of the first DCI;

FIG. 6 is a schematic diagram of a method for transmitting indication information of an embodiment a second aspect of this disclosure;

FIG. 7 is a schematic diagram of an apparatus for receiving indication information of an embodiment a third aspect of this disclosure;

FIG. 8 is a schematic diagram of an apparatus for transmitting indication information of the embodiment the third aspect of this disclosure;

FIG. 9 is a schematic diagram of a terminal equipment of an embodiment a fourth aspect of this disclosure; and

FIG. 10 is a schematic diagram of a network device of the embodiment of the fourth aspect of this disclosure.

### DETAILED DESCRIPTION OF THE DISCLOSURE

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “terminal equipment (TE) or terminal device”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. Uplink signals may include uplink data signals and/or uplink control signals, and may also be referred to as uplink transmissions (UL transmissions) or uplink information or uplink channels. Transmitting uplink transmission on an uplink resource may be understood as transmitting the uplink transmission by using the uplink resource. Likewise, downlink data/signals/channels/information may be understood accordingly.

In the embodiments of this disclosure, higher layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios of the embodiments of this disclosure shall be described below by way of examples; however, this disclosure is not limited thereto.

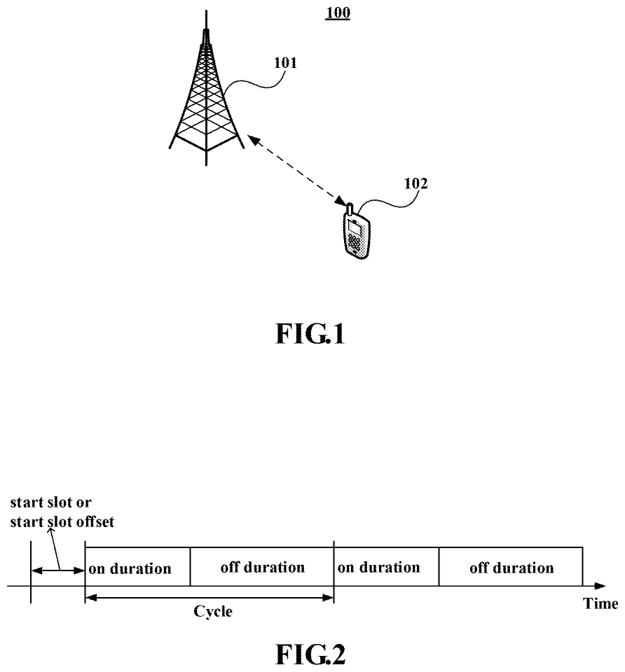

FIG. 1 is a schematic diagram of a communication system of an embodiment of this disclosure, in which a case where a terminal equipment and a network device are taken as examples is schematically shown. As shown in FIG. 1, the communication system 100 may include a network device 101 and a terminal equipment 102 (for the sake of simplicity, an example having only one terminal equipment is schematically given in FIG. 1).

In the embodiment of this disclosure, existing services or services that may be implemented in the future may be performed between the network device 101 and the terminal equipment 102. For example, such services may include but not limited to an enhanced mobile broadband (eMBB), massive machine type communication (mMTC), and ultra-reliable and low-latency communication (URLLC), etc.

Wherein, the terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

The embodiments of this disclosure may be applicable to scenarios including network devices and/or terminal equipments, such as the scenario of the communication system shown in FIG. 1.

The network device may include at least one of a core network device, a third-party application device, operation administration and maintenance (OAM), and an access network device. For example, in FIG. 1, that the network device is an access network device 101 is taken as an example.

The core network device may refer to a device in a core network (CN) providing service support to a terminal equipment. As some instances, the core network device may be at least one of the following: a mobility and management entity (MME), an access and mobility management function (AMF) entity, a session management function (SMF) entity, a user plane function (UPF) entity, and a location management function (LMF) entity, etc., which shall not be enumerated herein any further. The AMF entity may be responsible for access management and mobility management of a terminal, the SMF entity may be responsible for session management, such as establishment of a user session, and the UPF entity may be a functional entity of a user plane, and is mainly responsible for connection to external networks. It should be noted that in this disclosure, an entity may also be referred to as a network element or a functional entity, for example, the AMF entity may also be referred to as an AMF network element or an AMF functional entity.

The third-party application entity may be an OTT server (over the top server) or another third-party device.

The access network device is an access device of a terminal that accesses to a communication system in a wireless manner. The access network device may be a base station (BS), an evolved base station (evolved NodeB, eNodeB), a transmission reception point (TRP), a base station in a fifth generation (5G) mobile communication system (next generation NodeB, gNB), a base stations in a sixth generation (6G) mobile communication system, a base station in a future mobile communication system or access node in a WiFi system, etc.; the access network device may also be a module or unit that completes a part of functions of a base station, for example, it may be at least one of the following modules or units: a centralized unit (CU), a distributed unit (DU), a centralized unit control plane (CU-CP), a centralized unit user plane (CU-CP), an integrated access backhaul (IAB), or other modules or units. Specific techniques and/or specific device forms adopted by the access network device are not limited in the embodiments of this disclosure. The access network device may be deployed on the land, including indoors/outdoors, and may be handheld or on-board; and it may also be deployed on a water surface, an airplane, a balloon or a satellite. The access network device may be deployed at a fixed position or on a mobile carrier, which is not limited in the embodiments of this disclosure.

The terminal equipment (such as the terminal equipment 102 in FIG. 1) is an equipment having a function of wireless transmission and reception, and may transmit signals to the access network device and/or receive signals from the access network device. The terminal equipment may also be referred to as a terminal, a mobile station, and a mobile terminal, etc. The terminal equipment may be a mobile phone, a tablet, or other equipments having a function of wireless intelligent transmission and reception. The terminal equipment may be widely used in various scenarios, such as device-to-device (D2D), vehicle to everything (V2X) communication, machine-type communication (MTC), Internet of Things (IoT), virtual reality, augmented reality, industrial control, autonomous driving, telemedicine, or various intelligent scenarios.

Communication may be performed between the access network device and the terminal equipment and between terminal equipments via licensed spectra or via unlicensed spectra, or via licensed spectra and unlicensed spectra simultaneously. Spectrum resources used used in the wireless communication are not limited in the embodiments of this disclosure.

For ease of description, following description shall be given by taking a base station serving as an access network device as an example.

In the embodiments of this disclosure, the cell discontinuous transmission/reception (DTX/DRX) may also be referred to as cell discontinuous transmission or reception, which have identical meanings and may be interchangeable.

### Embodiment of a First Aspect

There are two modes of time domain energy saving of networks. Mode 1 is cell discontinuous transmission/reception (DTX/DRX), that is, by configuring an active period and an inactive period in a network device, the network device only transmits and receives signals during the active period, and restricts signal transmission and reception during the inactive period. Mode 2 is cell dormancy or shutdown, wherein once a cell enters dormancy or shutdown, the network device will stop transmission and reception of all signals in the cell. A UE served by the cell needs to hand over to other cells before the cell enters dormancy or shutdown.

In the following description of this disclosure, cell dormancy or shutdown is sometimes referred to as cell shutdown.

FIG. 2 is a schematic diagram of a cell DTX/DRX operation. As shown in FIG. 2, the network device configures periodic cell DTX/DRX settings by using UE-specific radio resource control (RRC) signaling, which includes the following contents: a cycle, a start slot or a start slot offset, and on duration. A time outside of the on duration is off duration.

Cell DTX and cell DRX may be configured separately, or only one of them may be configured.

The setting of cell DTX and cell DRX may be identical or different. For example, the active time and the cycle are set to be identical, but the start slot is set to be different.

During the active period of cell DTX, the terminal equipment performs normal reception of signals. During the inactive period of cell DTX, the terminal equipment performs restricted reception of signals. For example, the terminal equipment does not monitor physical downlink control channels (PDCCHs) and semi-persistent scheduling physical downlink shared channels (SPS-PDSCHs). The terminal equipment does not receive channel state information reference signals (CSI-RSs) for a periodic or semi-persistent channel measurement report. The channel measurement report here may be a report including a rank indicator (RI) report quantity.

During the active period of cell DRX, the terminal equipment performs normal transmission of signals. During the inactive period of cell DRX, the terminal equipment performs restricted transmission of signals, such as not transmitting a scheduling request (SR) and configured grant physical uplink shared channels (CG-PUSCHs). The terminal equipment does not transmit a periodic or semi-persistent channel measurement report. The channel measurement report here may be a report including an RI report quantity.

For the mode of cell dormancy, the network device uses UE-specific RRC signaling to configure cell handover settings under specific conditions in a network energy-saving mode, including a cell handover measurement condition, information on a target serving cell, and a cell handover execution condition, etc.

During a process of condition handover, the terminal equipment will not wait for that signals are completely lost or unusable, but will hand over to a target serving cell when a specific condition is satisfied. For example, when the terminal equipment receives an instruction and learns that a current serving cell is about to be dormant or shut down, and finds a target serving cell satisfying the condition through measurement, the terminal equipment may hand over from the current serving cell to the target serving cell.

In order to flexibly and efficiently notify the terminal equipment of information related to network energy saving, an embodiment of a first aspect of this disclosure provides a method for receiving indication information, applicable to a terminal equipment, such as the terminal equipment 102 shown in FIG. 1.

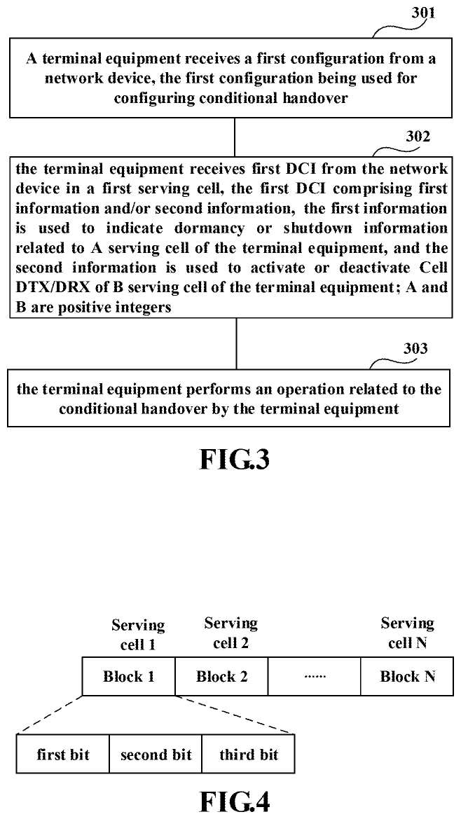

FIG. 3 is a schematic diagram of the method for receiving indication information of the embodiment the first aspect of this disclosure. As shown in FIG. 1, the method for receiving indication information includes:
operation 301: A terminal equipment receives a first configuration from a network device, the first configuration being used for configuring conditional handover;
operation 302: the terminal equipment receives first downlink control information (DCI) from the network device in a first serving cell, the first DCI comprising first information and/or second information, wherein the first information is used to indicate dormancy or shutdown information related to A serving cell of the terminal equipment, and the second information is used to activate or deactivate cell discontinuous transmission or reception (Cell DTX/DRX) of B serving cell of the terminal equipment; where, A and B are positive integers; and
operation 303: the terminal equipment performs an operation related to the conditional handover by the terminal equipment.

In this disclosure, the first DCI may be, for example, group-common DCI.

In operation 301 of this disclosure, this conditional handover may be used for energy saving of the network device, for example.

The first configuration may be, for example, a cell handover configuration under specific conditions in an energy-saving mode of the network device, wherein the first configuration includes at least one of the following contents: a measurement object; a reporting configuration; a measurement identity (measId); a conditional handover reconfiguration identity (CondReconfigId); and a measurement event.

The measurement object refers to information related to a target cell measured by the terminal equipment, which may be set to be multiple in a form of list. For example, intra-frequency measurements, inter-frequency measurements and inter-RAT (radio access technology) E-UTRA measurements may all be configured as measurement objects. In the case of inter-RAT EUTRA measurement, EUTRA frequencies are configured as measurement objects.

In addition, the measurement object may include a list of cells with cell-specific offsets, a list of blocked cells and a list of allowed cells. The cell-specific offsets refer to offsets added to measurement results during measurements, the list of blocked cells refers to a list of cells that are indicated as being unrelated (out of range) in event evaluation or measurement reports, and the list of allowed cells refers to a list of cells that are indicated as being related (within range) in event evaluation or measurement reports. In order to manage the measurement object, the network device sets a measurement object identifier (measObjectId) for each measurement object.

The reporting configuration contains information related to measurement reports, and one or more reporting configurations may be set for each measurement object. In order to manage the reporting configuration, the network device sets a reporting configuration identifier (reportConfigId) for each reporting configuration.

The measurement identifier (measId) is an identifier used to associate a measurement object identifier (measObjectId) with a reporting configuration identifier (reportConfigId). The measurement identifier may be set to be multiple in a form of list. With the measurement identifiers, multiple reporting configurations may be associated with one measurement object, or multiple measurement objects may be associated with identical reporting configurations.

The conditional handover reconfiguration identity (CondReconfigId) is used to identify and manage conditional handover settings. By associating the conditional handover reconfiguration identifier (CondReconfigId) with the measurement identifier (measId), conditions for the measurement event may be specified.

The measurement event includes, for example, at least one of A3 event, A4 event, and A5 event, etc., wherein,
A3 event: when signal quality of a neighbor cell is one offset better than that of a special serving cell, A3 event is triggered;
A4 event: when a signal strength of a neighbor cells is higher than preset threshold 1, A4 event is triggered; and
A5 event: when a signal strength of a special serving cell is lower than preset threshold 1 and the signal strength of the neighbor cell is lower than preset threshold 2, A5 event is triggered.

In addition, the first configuration may further include at least one of the following: target serving cell information, a handover parameter, a reselection parameter, and a handover execution condition, wherein,
the target serving cell information includes such information as a cell ID of the target serving cell, etc.;
the handover parameter includes a parameter that need to be considered in determining whether a measurement event is satisfied, such as a threshold, etc.;
the reselection parameter refers to information on how the terminal equipment reselects a serving cell after handover, such as a reselection threshold, and a reselection timer, etc.;
and the execution condition is that, for example, receiving a DCI format and notifying that a source serving cell is about to enter a dormant/shutdown state, and the UE finds a target serving cell satisfying the measurement event through measurement.

In at least one embodiment of operation 301, the terminal equipment may further receive at least one of a second configuration, a third configuration and a fourth configuration from the network device.

The second configuration is used to configure dormancy or shutdown of the A serving cells.

The third configuration is used to configure cell discontinuous transmission and/or cell discontinuous reception of the B serving cells. For example, the third configuration is used to configure cell discontinuous transmission of the B serving cells, and may include cellDTXConfig; for another example, the third configuration is used to configure cell discontinuous reception of the B serving cells, and may include cellDRXConfig.

In at least one embodiment, when the third configuration is used to configure cell discontinuous transmission of the B serving cells, the third configuration may include one or more of the following contents: a cell DTX cycle, a cell DTX start slot or start slot offset, and cell DTX on duration.

When the third configuration is used to configure cell discontinuous reception of the B serving cells, the third configuration may include one or more of the following contents: a cell DRX cycle, a cell DRX start slot or start slot offset, and cell DRX on duration.

If the third configuration is used to configure cell discontinuous reception and cell transmission of the B serving cells, configuration for cell discontinuous reception and configuration for cell discontinuous transmission may be identical or different. For example, the on duration and the cycle are set to be identical, but the start slots are set to be different.

Third configurations of different serving cells may be identical or different.

The fourth configuration is used to configure information related to reception of the first DCI. The fourth configuration includes at least one of the following contents: a size of the first DCI (e.g. sizeDCI-2-9); a radio network temporary identifier (RNTI) of the network energy-saving mode for scrambling cyclic redundancy check (CRC) of the first DCI, such as an NESCHO-RNTI; a search space of the first DCI; a start bit position that the terminal equipment needs to monitor, such as positionInDCI-cellDTRX; and corresponding information of the start bit position that the terminal equipment needs to monitor and the cell ID of the serving cell (or a combination of cell IDs of multiple serving cells).

The serving cell may be a primary serving cell (PCell), or an secondary serving cell (SCell), or a special serving cell (SpCell). The one or more serving cells may be within a cell group or within different cell groups. The special serving cell refers to a primary serving cell in a master cell group or a secondary cell group.

In this disclosure, for A and B described in operation 302, A may be equal to B, or A and B may not be equal. The A serving cells and B serving cells may be completely identical, or partially overlap, or not overlap.

In this disclosure, there may be various embodiments of the first DCI for a mode of carrying the first information and/or the second information.

In at least some embodiments, the first information may be carried by A blocks in the first DCI, and/or the second information may be carried by B blocks in the first DCI. The A blocks are in a one-to-one correspondence with the A serving cells, and/or the B blocks are in a one-to-one correspondence with the B serving cells, the one-to-one correspondences being configured by the network device. In addition, start bit positions of the blocks are determined by higher layer parameters. Each block at least includes one bit, or, the blocks include bitmaps.

In at least some other embodiments, the first information is carried by A1 blocks in the first DCI, and the second information is carried by B1 blocks in the first DCI; where, A1 and B1 are positive integers, A1 is less than or equal to A, and B1 is less than or equal to B. The A1 blocks are in a one-to-one correspondence with the A1 serving cells, and/or the B1 blocks are in a one-to-one correspondence with the B1 serving cells, the one-to-one correspondences being configured by the network device. In addition, start bit positions of the blocks are determined by higher layer parameters. Each block at least includes one bit, or, the blocks include bitmaps.

For example, the A serving cells are A1 serving cell groups, and/or the B serving cells are B1 serving cell groups.

In at least one embodiment of this disclosure, in the first DCI, one block may include at least one of a first bit, a second bit and a third bit, wherein the first bit, the second bit and the third bit respectively include at least one bit.

The first bit is used to denote activation or deactivation of discontinuous transmission of a serving cell or a serving cell group corresponding to the block, the second bit is used to denote activation or deactivation of discontinuous reception of a serving cell or a serving cell group corresponding to the block, and the third bit is used to denote dormancy or shutdown information of a serving cell or a serving cell group corresponding to the block.

For example, the third bit includes one bit. When the one bit is a first value, it indicates that the serving cell or serving cell group corresponding to the block is not shut down or not dormant or shutdown or dormancy thereof is about to end. When the one bit is a second value, it indicates that the serving cell or serving cell group corresponding to the block is about to shut down or enter into dormancy.

In the embodiment where a block may contain at least one of the first bit, the second bit and the third bit, in the block including the first bit, the second bit and the third bit,
the first bit is a most significant bit of the block, the second bit is a second most significant bit, and the third bit is a least significant bit; or
the third bit is a most significant bit of the block, the second bit is a second most significant bit, and the first bit is a least significant bit.

In at least one embodiment, the terminal equipment receives the second configuration in operation 301. The second serving cell or second serving cell group of the terminal equipment is included in the A serving cells, and a block in the first DCI corresponding to the second serving cell or second serving cell group at least includes the third bit; and/or,

The terminal equipment receives the third configuration, the second serving cell or second serving cell group of the terminal equipment is included in the B serving cells, the third configuration includes a cell discontinuous transmission configuration of the second serving cell or the second serving cell group, and the block in the first DCI corresponding to the second serving cell or the second serving cell group at least includes the first bit; and/or,

The terminal equipment receives the third configuration, the second serving cell or second serving cell group of the terminal equipment is included in the B serving cells, the third configuration includes a cell discontinuous reception configuration of the second serving cell or the second serving cell group, and the block in the first DCI corresponding to the second serving cell or the second serving cell group at least includes the second bit.

In at least another embodiment, the terminal equipment receives the second configuration and the third configuration in operation 301. A third serving cell or third serving cell group of the terminal equipment is included in both the A serving cells and the B serving cells, and the first information and the second information corresponding to the third serving cell or the third serving cell group are carried by one block.

For example, the block used to carry the first information corresponding to the third serving cell or the third serving cell group is identical to the block used to carry the second information corresponding to the third serving cell, that is, the first information and the second information corresponding to the third serving cell or the third serving cell group are carried by the same block.

In addition, in other embodiments of this disclosure, the first information and the second information may also be carried by different blocks, or a mode for scrambling the first DCI including the first information may be different from a mode for scrambling the first DCI including the second information. Explanations of the other embodiments shall be elaborated in subsequent embodiments.

With operation 302, the terminal equipment 302 receives the first DCI and is able to acquire the first information and/or the second information, thereby being indicated information related to energy saving of the network device.

In operation 303 of this disclosure, the terminal equipment performs operations related to conditional handover, wherein the operations related to conditional handover include at least one of the following operations:
performing the conditional handover at least according to the first configuration; and
cancelling conditional handover related to the first configuration by the terminal equipment, wherein the cancelling conditional handover related to the first configuration may also be referred as stopping or suspending or releasing or terminating conditional handover related to the first configuration.

In operation 303, the terminal equipment performs operations related to conditional handover, and the operations related to conditional handover may further include at least one of the following operations:
receiving the first information by the terminal equipment at a first slot of the first serving cell, the first information indicating to the terminal equipment that a fourth serving cell of the terminal equipment is about to be shut down or dormant; and
performing the conditional handover by the terminal equipment by taking the fourth serving cell as a source cell.

In operation 303, the terminal equipment performs operations related to conditional handover, and the operations related to conditional handover may further include at least one of the following operations:
receiving the first information by the terminal equipment at a first slot of the first serving cell, the first information indicating to the terminal equipment that a fifth serving cell of the terminal equipment is not shut down or not dormant, or that shutdown or dormancy of the fifth serving cell is about to end; and
cancelling the ongoing conditional handover with the fifth serving cell as a source cell by the terminal equipment, wherein canceling the conditional handover may be referred to as stopping or suspending or releasing or terminating the conditional handover.

In operation 303, in the operations related to conditional handover performed by the terminal equipment, there may be the following operations:
determining at least according to the first configuration that a sixth cell is a target cell, and performing conditional handover by taking the fourth serving cell as a source cell and the sixth cell as a target cell, by the terminal equipment; and/or,
not monitoring the first DCI by the terminal equipment from a second slot (e.g. slot m+d1; where, d1 is a natural number) to a third slot (e.g. m+d2; where, d2 is a positive integer); and/or,
not monitoring the first DCI by the terminal equipment before the conditional handover operation is completed.

Wherein, d1 is the number of slots of a subcarrier spacing (SCS) of an active downlink bandwidth part (DL BWP) of the fourth serving cell, and a value of d1 may be zero, or a value of d1 may be identical to values in Table 1.

TABLE 1

| SCS (kHz) | Number of slots |
|---|---|
| 15 | 3 |
| 30 | 6 |
| 60 | 12 |
| 120 | 24 |
| 480 | 96 |
| 960 | 192 |

d2 corresponds to the number of slots of the SCS of the active DL BWP of the fourth serving cell, and a value of d2 may be identical to or different from the values in Table 1, or a difference between d1 and d2 may be identical to the values in Table 1.

In addition, in this disclosure, in a case where a block used to carry the first information to which a seventh serving cell or a seventh serving cell group corresponds and a block used to carry the second information to which the seventh serving cell or the seventh serving cell group corresponds in the first DCI (e.g. an index of the block carrying the first information and an index of the block carrying the second information) are identical or different,
the terminal equipment does not expect that the block carrying the first information and the block carrying the second information are valid simultaneously; and/or,
the terminal equipment does not expect that the first information indicates that the seventh serving cell or the seventh serving cell group is shut down or dormant and the second information indicates a change in an active or inactive state of cell discontinuous transmission or reception of the seventh serving cell or the seventh serving cell group; and/or,
the first information indicates that the seventh serving cell or the seventh serving cell group is shut down or dormant, and the terminal equipment ignores the second information or does not monitor the second information or does not report the second information to a higher layer or does not receive the second information.

The method for receiving indication information of this disclosure shown in FIG. 3 shall be described below with reference to various examples.

### Example 1

In Example 1, the method for receiving indication information may include operations 301, 302 and 303 shown in FIG. 3.

In Example 1, reference may be made to the above explanations for explanations of operation 301.

In operation 302 of Example 1, the terminal equipment receives the first DCI (e.g. group-common DCI) transmitted by the network device. The first DCI, for example, uses CRC scrambled by a time-domain network energy-saving RNTI (such as NESCHO-RNTI).

FIG. 4 is a schematic diagram of the first DCI. As shown in FIG. 4, the first DCI includes at least one block, i.e. block 1, block 2 . . . block N, wherein a start bit position of the block is determined by a parameter (e.g. positionInDCI-cellDTRX) configured for the terminal equipment by a higher layer (e.g. an RRC layer). Wherein, one block corresponds to one serving cell or one serving cell group. The start bit position of the block and the corresponding serving cell or serving cell group are determined by the parameter configured by the higher layer.

In Example 1, the terminal equipment is configured with cell DTX and/or cell DRX and/or cell handover configuration information under specific conditions in the network energy-saving mode. The higher layer configures one or more blocks for the terminal equipment, and defines the following fields for each block:
cell DTX (i.e. a first bit)/cell DRX (i.e. a second bit)/cell shutdown (i.e. a third bit),
if the terminal equipment receives the second configuration and the third configuration and the third configuration is used to configure cell DTX and cell DRX, the first bit, the second bit and the third bit may respectively include one bit.

For example, the most significant bit (MSB) corresponds to the first bit, the second most significant bit (SMB) corresponds to the second bit, and the least significant bit (LSB) corresponds to the third bit;
for example, the most significant bit (MSB) corresponds to the third bit, the second most significant bit (SMB) corresponds to the second bit, and the least significant bit (LSB) corresponds to the first bit.

In addition, the first bit, the second bit and the third bit may also be set in other forms.

If the terminal equipment receives two of the second configuration, the third configuration for configuring cell DTX, and the third configuration for configuring cell DTX, each block of the first DCI may include 2 bits, corresponding respectively to two of the first bit, the second bit and the third bit.

For example, if the terminal equipment receives the third configuration and the third configuration is used for configuring cell DTX and cell DRX, the MSB of the block corresponds to the first bit, and the LSB thereof corresponds to the second bit. In addition, the first bit, the second bit and the third bit may also be set in other forms.

If the terminal equipment receives two of the second configuration, the third configuration for configuring cell DTX and the third configuration for configuring cell DTX, each block of the first DCI may include one bit, corresponding to one of the first bit, the second bit and the third bit.

If the terminal equipment receives the third configuration for configuring cell DTX, the bit corresponds to the first bit; and if the terminal equipment receives the third configuration for configuring cell DRX, the bit corresponds to the second bit.

Corresponding to the first bit and/or the second bit, that the bit is 0 may indicate deactivation of cell DTX and/or cell DRX, and that the bit is 1 indicates activation of cell DTX and/or cell DRX.

Corresponding to the third bit, for example, that the bit is 0 indicates that the serving cell or the serving cell group is not shut down, that the bit is 1 indicates that the serving cell or the serving cell group is about to be shut down, or that the bit is 0 indicates that the serving cell or the serving cell group is about to be shut down, and that the bit is 1 indicates that the serving cell or the serving cell group is not shut down.

In this disclosure, a size of the first DCI may be aligned with sizes of other DCI, which may be indicated by, for example, a higher layer parameter (e.g. sizeDCI).

If the terminal equipment has established connection with multiple serving cells, the terminal equipment does not expect to monitor physical downlink control channels (PDCCHs) of multiple serving cells to detect the first DCI; or, the terminal equipment does not expect to monitor PDCCHs of multiple serving cells in a cell group to detect the first DCI.

In operation 303 of Example 1, the terminal equipment performs the following operations that:
if the first DCI indicates activation or deactivation of cell DTX or cell DRX,
when the terminal equipment receives a PDCCH providing the first DCI on a slot m of an active DL BWP of serving cell 1 and the first DCI indicates a change in an active or inactive state of current cell DTX or cell DRX of serving cell 2, the terminal equipment performs UE behaviors of transmission and reception of handover signals on serving cell 2 according to the indicated cell DTX or cell DRX, starting from a slot on an active DL BWP or active UL BWP of serving cell 2, the slot being not earlier than start of slot m+d0 on an active DL BWP of serving cell 1. Reference may be made to Table 1 for explanations of do.

Wherein, serving cell 1 and serving cell 2 may be identical or different.

If the first DCI indicates cell shutdown,
when the terminal equipment receives a PDCCH providing the DCI format on slot m of the active DL BWP of serving cell 1 and the DCI format indicates a cell shutdown indication of a current cell of serving cell 2, the terminal equipment performs a cell handover operation under specific conditions in the network energy-saving mode (i.e. conditional handover), wherein,
if the terminal equipment finds a target serving cell satisfying the specific conditions under the network energy-saving mode, the terminal equipment immediately performs a cell handover operation;
between slot m+d1 and m+d2, the terminal equipment does not need to monitor PDCCHs to detect the DCI format, wherein d1 and d2 correspond to the number of slots of an SCS of the active DL BWP of serving cell 1, and a difference between d1 and d2 may be identical to or different from the values in Table 1; or, before completing the cell handover operation, the terminal equipment does not need to monitor PDCCHs to detect the DCI format.

For the first information and the second information contained in a block to which the same serving cell or serving cell group corresponds, the terminal equipment does not expect that there simultaneously exist following two indications:
a change in the active or inactive state of cell DTX or cell DRX; and
cell shutdown.

Or, for a block to which a serving cell or a serving cell group corresponds, if cell shutdown is indicated, the terminal equipment ignores the second information contained in the block to which the same serving cell or serving cell group corresponds (i.e. an indication of activation or deactivation of cell DTX or cell DRX), such as ignoring the second information or not monitoring the second information or not reporting the second information to a higher layer or not receiving the second information.

Specifically, for a case where a block includes the first information and the second information, the terminal equipment does not expect that there simultaneously exist following two indications:
a change in the active or inactive state of cell DTX or cell DRX; and
cell shutdown.

Or, if a block indicates cell shutdown, the terminal equipment ignores the second information contained in the same block (i.e. an indication of activation or deactivation of cell DTX or cell DRX), such as ignoring the second information or not monitoring the second information or not reporting the second information to a higher layer or not receiving the second information.

### Example 2

In Example 2, the method for receiving indication information may include operations 301, 302 and 303 shown in FIG. 3.

In Example 2, reference may be made to operation 301 in Example 1 for operation 301. In addition, in Example 2, a start bit position included in fourth configuration information received in operation 301 that the terminal equipment needs to monitor may be one or more, that is, the start bit position may be a start bit position to which a block of the first information corresponds, and/or a start bit position to which a block of the second information corresponds, such as positionInDCI-cellDTRX and/or positionInDCI-NESCHO. In addition, in Example 2, the fourth configuration information received in operation 301 may further include corresponding information of the start bit position that the terminal equipment needs to monitor and the cell ID of the serving cell (or a combination of cell IDs of multiple serving cells).

In operation 302 of Example 2, the terminal equipment receives the first DCI (e.g. group-common DCI) transmitted by the network device. The first DCI, for example, uses CRC scrambled by a time-domain network energy-saving RNTI (such as NESCHO-RNTI).

In one example of Example 2,
the terminal equipment receives the third configuration, a ninth serving cell or a ninth serving cell group of the terminal equipment is at least included in the B serving cells, the third configuration includes cell discontinuous transmission configuration and cell discontinuous reception configuration of the ninth serving cell or the ninth serving cell group, and a second block in the first DCI used to carry the second information to which the ninth serving cell or the ninth serving cell group corresponds includes the first bit and the second bit; or,
the terminal equipment receives the third configuration, a ninth serving cell or a ninth serving cell group of the terminal equipment is at least included in the B serving cells, the third configuration includes cell discontinuous transmission configuration and cell discontinuous reception configuration of the ninth serving cell or the ninth serving cell group, and a second block in the first DCI used to carry the second information to which the ninth serving cell or the ninth serving cell group corresponds includes the first bit or the second bit,
wherein the first bit and the second bit respectively include at least one bit.

In another example of Example 2,
the terminal equipment receives the second configuration, the ninth serving cell or the ninth serving cell group is also included in the A serving cells, and the first information corresponding to the ninth serving cell or the ninth serving cell group is carried by the first block of the first DCI.

Wherein, the start bit position of the first block is determined by a first higher layer parameter, and the start bit position of the second block is determined by a second higher layer parameter, the first higher layer parameter and the second higher layer parameter are carried by the fourth configuration. The second block includes a third bit, wherein the third bit includes at least one bit, or the third bit includes a bitmap.

FIG. 5 is a schematic diagram of the first DCI. As shown in FIG. 5, the first DCI includes at least one block, i.e. block 1, block 2 . . . block N, wherein a start bit position of the block that the terminal equipment needs to monitor is determined by a parameter (e.g. positionInDCI-cellDTRX and/or positionInDCI-NESCHO) configured for the terminal equipment by a higher layer (e.g. an RRC layer). One block corresponds to one serving cell or one serving cell group, and a start bit position of the block and the corresponding serving cell or serving cell group are determined by the parameter configured by the higher layer.

If the terminal equipment receives the third configuration and the third configuration configures cell DTX and/or cell DRX, the higher layer configures the terminal equipment with one or more blocks corresponding to a start bit position indicated by a first higher layer parameter (e.g. positionInDCI-cellDTRX), and defines a first bit and/or a second bit for each block.

Wherein, if the third configuration received by the terminal equipment configures cell DTX and cell DRX, the first bit and the second bit respectively include one bit, that is, the block to which the second information corresponds includes 2 bits. An MSB of the block corresponds to the first bit, and an LSB thereof corresponds to the second bit; or, the MSB of the block corresponds to the second bit, and the LSB thereof corresponds to the first bit.

If the third configuration received by the terminal equipment configures cell DTX or cell DRX, the block to which the second information corresponds includes 1 bit. For example, if the third configuration configures cell DTX, the bit corresponds to the first bit, and if the third configuration configures cell DRX, the bit corresponds to the second bit.

Corresponding to the first bit or the second bit, that a value of the bit is 0 indicates deactivation, that a value of the bit is 1 indicates activation; or, that a value of the bit is 1 indicates deactivation, and that a value of the bit is 0 indicates activation.

If the terminal equipment receives the second configuration, the higher layer configures the terminal equipment with one or more blocks corresponding to a start bit position indicated by a second higher layer parameter (e.g. positionInDCI-NESCHO), and defines a third bit for each block.

The third bit may indicate whether a serving cell or a combination of serving cells is shut down via one bit. When the 1 bit is 0, it indicates not shutting down, and when the 1 bit is 1, it indicates being to shut down; or, when the 1 bit is 0, it indicates being to shut down, and when the 1 bit is 1, it indicates not shutting down.

The third bit may also be a bitmap. In this bitmap, each 1 bit corresponds to a serving cell or a combination of serving cells, wherein a size of the bitmap is determined by a parameter configured by the higher layer, for example, the size of the bitmap is in consistence with the number of serving cells or the number of serving cell groups configured by the higher layer.

In this bitmap, for a value of each bit, for example, 0 denotes an indication of not shutting down, 1 denotes an indication of being to shut down; or, 0 denotes an indication of being to shut down, 1 denotes an indication of not shutting down.

In Example 2, in this disclosure, the size of the first DCI may be aligned with sizes of other DCI, which may be, for example, indicated by the higher layer parameter (e.g. sizeDCI).

If the terminal equipment has established connection with multiple serving cells, the terminal equipment does not expect to monitor physical downlink control channels (PDCCHs) of the multiple serving cells to detect the first DCI; or, the terminal equipment does not expect to monitor PDCCHs of multiple serving cells within a cell group to detect the first DCI.

Operation 303 in Example 2 is identical to operation 303 in Example 1.

### Example 3

In Example 3, the method for receiving indication information may include operations 301, 302 and 303 shown in FIG. 3.

In Example 3, reference may be made to operation 301 in Example 1 for operation 301. In addition, in Example 3, the fourth configuration information received in operation 301 may further include a first RNTI and/or a second NRTI.

The first RNTI is an RNTI (e.g, NESCHO-RNTI) related to conditional handover (such as cell handover under specific conditions in the network energy-saving mode). The second NRTI is an RNTI used for scrambling the second DCI, and may be an RNTI of cell discontinuous transmission or reception, such as cellDTRX-RNTI.

The second DCI includes second information, the second information being used to activate or deactivate cell discontinuous transmission or reception (Cell DTX/DRX) of the B serving cells or B1 serving cell groups of the terminal equipment; where, B and B1 are positive integers.

In Example 3, the fourth configuration information received in operation 301 may include a search space of the first DCI and/or the second DCI, a start bit position (e.g. positionInDCI-cellDTRX and/or positionInDCI-NESCHO) that one or more terminal equipments need to monitor, and corresponding information of the start bit position that the terminal equipment(s) need(s) to monitor and the cell ID of the serving cell (or a combination of cell IDs of multiple serving cells).

In operation 302 of Example 3, the terminal equipment receives the first DCI (e.g. group-common DCI) transmitted by the network device. The first DCI uses, for example, CRC scrambled by the first RNTI (e.g. NESCHO-RNTI).

The first DCI may include block 1, block 2 . . . , block N, wherein start bit positions of the blocks are determined by a parameter (e.g. positionInDCI-NESCHO) configured by the higher layer (RRC layer) for the terminal equipment.

Wherein, the blocks correspond to the serving cell or the serving cell group. The start bit positions of the blocks and the corresponding serving cell or serving cell group are determined by the parameter configured by the higher layer.

The higher layer configures one or more blocks for the terminal equipment, and defines the third bit for each block. The third bit is used to indicate shutdown of the serving cell or the serving cell group.

The third bit may be one bit, which corresponds to a serving cell or a serving cell group. For example, when the 1 bit is 0, it indicates not shutting down, and when the 1 bit is 1, it indicates being to shut down; or, when the 1 bit is 0, it indicates being to shut down, and when the 1 bit is 1, it indicates not shutting down.

The third bit may also be a bitmap. In this bitmap, 1 bit corresponds to a serving cell or a serving cell group. A size of the bitmap is determined by a parameter configured by the higher layer, for example, the size of the bitmap is in consistence with the number of serving cells or the number of serving cell groups configured by the higher layer.

In this bitmap, for a value of each bit, for example, 0 denotes not shutting down, 1 denotes an indication of being to shut down; or, 0 denotes an indication of being to shut down, 1 denotes an indication of not shutting down.

In operation 302 of Example 3, the terminal equipment receives the second DCI (e.g. group-common DCI) transmitted by the network device. The second DCI uses, for example, CRC scrambled by a second RNTI (e.g. cellDTRX-RNTI).

The second DCI may include block 1, block 2 . . . , block N, wherein start bit positions of the blocks are determined by a parameter (e.g. positionInDCI-cellDTRX) configured by the higher layer (RRC layer) for the terminal equipment.

Wherein, the blocks correspond to the serving cell or the serving cell group. The start bit positions of the blocks and the corresponding serving cell or serving cell group are determined by the parameter configured by the higher layer.

The blocks of the second DCI may carry the second information.

The higher layer configures one or more blocks for the terminal equipment, and defines the first bit and/or the second bit for each block. The first bit indicates cell DTX, and the second bit indicates cell DRX.

If the third configuration received by the terminal equipment configures cell DTX and cell DRX, the second information of the block is 2 bits, for example, an MSB of the block corresponds to the first bit, and LSB thereof corresponds to the second bit.

If the third configuration received by the terminal equipment configures either cell DTX or cell DRX, the second information of the block is 1 bit. For example, if the third configuration received by the terminal equipment configures cell DTX, the 1 bit corresponds to the first bit, and if the third configuration received by the terminal equipment configures cell DRX, the 1 bit corresponds to the second bit.

Corresponding to the 1 bit in the first bit and/or the second bit, that the 1 bit is 0 indicates deactivation, and that the 1 bit is 1 indicates activation; or, that the 1 bit is 1 indicates deactivation, and that the 1 bit is 0 indicates activation.

In Example 3, in this disclosure, a size/sizes of the first DCI and/or the second DCI may be aligned with sizes of other DCI, which is indicated by, for example, a higher layer parameter (e.g. sizeDCI).

If the terminal equipment has established connection with multiple serving cells, the terminal equipment does not expect to monitor physical downlink control channels (PDCCHs) of the multiple serving cells to detect the first DCI; or, the terminal equipment does not expect to monitor PDCCHs of multiple serving cells within a cell group to detect the first DCI.

If the terminal equipment has established connection with multiple serving cells, the terminal equipment does not expect to monitor physical downlink control channels (PDCCHs) of multiple serving cells to detect the second DCI; or, the terminal equipment does not expect to monitor PDCCHs of multiple serving cells within a cell group to detect the second DCI.

Operation 303 in Example 3 is identical operation 303 in Example 1.

In this disclosure, the above operations 403, 405 and 406 may be taken as a separate embodiment, which is used to implement: monitoring configuration information according to the network device at the terminal equipment side, monitoring resource information at the terminal equipment side, and reporting to the network device.

According to the embodiment of the first aspect of this disclosure, the terminal equipment receives the first downlink control information (DCI) related to network energy saving from the network device, hence, information related to network energy saving may be flexibly and efficiently notified to the terminal equipment, and network efficiency and network energy saving gains may be improved.

### Embodiment of a Second Aspect

The embodiment of the second aspect provides a method for transmitting indication information, which is used for solving technical problems identical or similar to those described in the embodiment of the first aspect. This method is applicable to a network device, such as the network device 101 shown in FIG. 1.

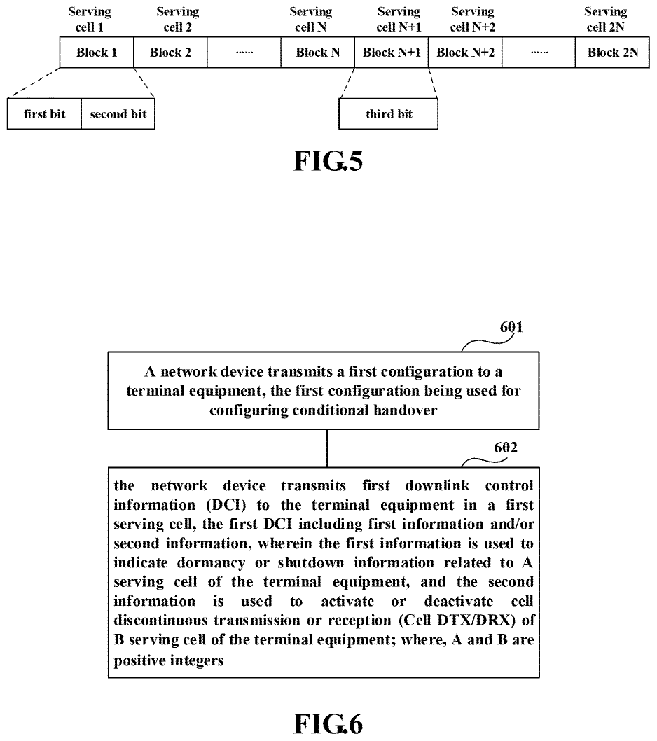

FIG. 6 is a schematic diagram of the method for transmitting indication information of the embodiment of the second aspect of this disclosure. As shown in FIG. 6, the method for transmitting indication information includes:
operation 601: A network device transmits a first configuration to a terminal equipment, the first configuration being used for configuring conditional handover;
operation 602: the network device transmits first downlink control information (DCI) to the terminal equipment in a first serving cell, the first DCI including first information and/or second information, wherein the first information is used to indicate dormancy or shutdown information related to A serving cell of the terminal equipment, and the second information is used to activate or deactivate cell discontinuous transmission or reception (Cell DTX/DRX) of B serving cell of the terminal equipment; where, A and B are positive integers.

In this disclosure, the terminal equipment is able to perform operations related to the conditional handover, the operations including at least one of the following operations:
performing the conditional handover at least according to the first configuration; or
cancelling conditional handover related to the first configuration by the terminal equipment.

In at least one embodiment, the conditional handover is used for energy saving of the network device.

In at least one embodiment, the first configuration includes:
a measurement object; and/or
a reporting configuration; and/or
a measurement identity (measId); and/or
a conditional handover reconfiguration identity (CondReconfigId); and/or
a measurement event.

In at least one embodiment, the first DCI is group-common DCI.

In at least one embodiment, the method further includes:
transmitting a fourth configuration by the network device to the terminal equipment, the fourth configuration being used to configure information related to reception of the first DCI.

In at least one embodiment, A is equal to or not equal to B.

In at least one embodiment, the first information is carried by A blocks in the first DCI, and/or the second information is carried by B blocks in the first DCI.

In at least one embodiment, the A blocks have a one-to-one correspondence with the A serving cells, and/or the B blocks have a one-to-one correspondence with the B serving cells, the one-to-one correspondences being configured by the network device.

In at least one embodiment, the first information is carried by A1 blocks in the first DCI, and the second information is carried by B1 blocks in the first DCI; where, A1 and B1 are positive integers, A1 is less than or equal to A, and B1 is less than or equal to B.

In at least one embodiment, the A serving cells are A1 serving cell groups, and/or the B serving cells are B1 serving cell groups, and the A1 blocks have a one-to-one correspondence with the A1 serving cell groups, and/or the B1 blocks have a one-to-one correspondence with the B1 serving cell groups, the one-to-one correspondences being configured by the network device.

In at least one embodiment, a start bit position of the blocks is determined by a higher layer parameter.

In at least one embodiment, the blocks include at least 1 bit, or, the blocks include a bitmap.

In at least one embodiment, the method further includes:
transmitting a second configuration and/or a third configuration to the terminal equipment, the second configuration being used to configure dormancy or shutdown of the A serving cells, and the third configuration being used to configure cell discontinuous transmission and/or cell discontinuous reception of the B serving cells.

In at least one embodiment, a block in the first DCI includes at least one of a first bit, a second bit or a third bit,
the first bit, the second bit and the third bit each including at least one bit.

In at least one embodiment, the first bit is used to denote activation or deactivation of discontinuous transmission of a serving cell or a serving cell group corresponding to the block;
the second bit is used to denote activation or deactivation of discontinuous reception of a serving cell or a serving cell group corresponding to the block;
and the third bit is used to indicate dormancy or shutdown information of a serving cell or a serving cell group corresponding to the block.

In at least one embodiment, the third bit includes 1 bit,
wherein the 1 bit is a first value, and the serving cell or the serving cell group corresponding to the block is not shut down or is not dormant, or shutdown or dormancy thereof is about to end;
and the first bit is a second value, and the serving cell or the serving cell group corresponding to the block is about to be shut down or dormant.

In at least one embodiment, the second configuration is transmitted, a second serving cell or a second serving cell group of the terminal equipment is included in the A serving cells, and the block in the first DCI corresponding to the second serving cell or the second serving cell group at least includes the third bit; and/or,
the third configuration is transmitted, a second serving cell or a second serving cell group of the terminal equipment is included in the B serving cells, the third configuration includes a cell discontinuous transmission configuration of the second serving cell or the second serving cell group, and the block in the first DCI corresponding to the second serving cell or the second serving cell group at least includes the first bit; and/or,
the third configuration is transmitted, a second serving cell or a second serving cell group of the terminal equipment is included in the B serving cells, the third configuration includes a cell discontinuous reception configuration of the second serving cell or the second serving cell group, and the block in the first DCI corresponding to the second serving cell or the second serving cell group at least includes the second bit.

In at least one embodiment, in the first DCI, in the block including the first bit, the second bit and the third bit,
the first bit is a most significant bit of the block, the second bit is a second most significant bit, and the third bit is a least significant bit; or
the third bit is a most significant bit of the block, the second bit is a second most significant bit, and the first bit is a least significant bit.

In at least one embodiment, the second configuration and the third configuration are transmitted,
a third serving cell or third serving cell group of the terminal equipment is included in both the A serving cells and the B serving cells, and the first information and the second information corresponding to the third serving cell or the third serving cell group are carried by one block.

In at least one embodiment, the first information is transmitted at a first slot (m) of the first serving cell, the first information indicating that a fourth serving cell of the terminal equipment is about to be shut down or dormant.

In at least one embodiment, the terminal equipment receives the first information at a first slot (e.g. slot m) of the first serving cell, the first information indicating that a fifth serving cell of the terminal equipment is not shut down or not dormant, or that shutdown or dormancy of the fifth serving cell is about to end.

In at least one embodiment, the third configuration is transmitted, a ninth serving cell or a ninth serving cell group of the terminal equipment is at least included in the B serving cells, the third configuration includes cell discontinuous transmission configuration and cell discontinuous reception configuration of the ninth serving cell or the ninth serving cell group, and a second block in the first DCI used to carry the second information to which the ninth serving cell or the ninth serving cell group corresponds includes the first bit and the second bit; or,
the third configuration is transmitted, a ninth serving cell or a ninth serving cell group of the terminal equipment is at least included in the B serving cells, the third configuration includes cell discontinuous transmission configuration and cell discontinuous reception configuration of the ninth serving cell or the ninth serving cell group, and a second block in the first DCI used to carry the second information to which the ninth serving cell or the ninth serving cell group corresponds includes the first bit or the second bit;
wherein the first bit and the second bit respectively include one bit.

In at least one embodiment, the second configuration is transmitted,
the ninth serving cell or the ninth serving cell group is also included in the A serving cells, and the first information corresponding to the ninth serving cell or the ninth serving cell group is carried by the first block of the first DCI.

In at least one embodiment, the start bit position of the first block is determined by a first higher layer parameter,
and the start bit position of the second block is determined by a second higher layer parameter,
wherein the first higher layer parameter and the second higher layer parameter are carried by the fourth configuration.

In at least one embodiment, the second block includes a third bit, wherein the third bit includes at least one bit, or the third bit includes a bitmap.

In at least one embodiment, the first DCI includes first information, wherein the first information is scrambled according to a first RNTI, the first RNTI being an RNTI related to conditional handover.

In at least one embodiment, the method further includes:
transmitting second DCI to the terminal equipment, the second DCI including second information, the second information being used to activate or deactivate cell discontinuous transmission or reception (Cell DTX/DRX) of the B serving cells or B1 serving cell groups of the terminal equipment; where, B and B1 are positive integers,
and the second DCI is scrambled according to a second RNTI.

In at least one embodiment, the method further includes:
transmitting the first RNTI, the first RNTI being an RNTI related to conditional handover; and/or,
transmitting the second RNTI, the second RNTI being a radio network temporary identifier (RNTI) of cell discontinuous transmission or reception.

According to the embodiment of the second aspect of this disclosure, the network device transmits downlink control information (DCI) related to network energy saving to the terminal equipment, hence, information related to network energy saving may be flexibly and efficiently notified to the terminal equipment, and network efficiency and network energy saving gains may be improved.

### Embodiment of a Third Aspect

The embodiment of the third aspect provides an apparatus for receiving indication information, applicable to a terminal equipment, and corresponding to the embodiment of the first aspect.

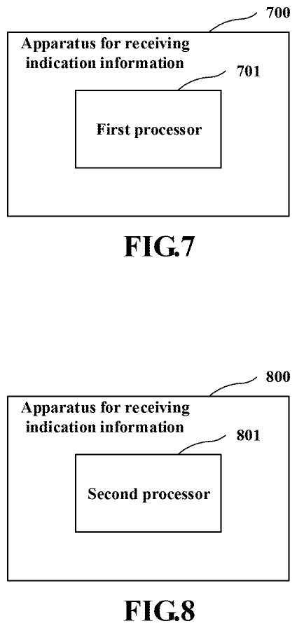

FIG. 7 is a schematic diagram of the apparatus for receiving indication information of the embodiment the third aspect of this disclosure. As shown in FIG. 7, the apparatus 700 for receiving indication information includes a first processor 701.

The first processor 701 controls the terminal equipment to perform the method for receiving indication information described in the embodiment of the first aspect.

The embodiment of the third aspect further provides an apparatus for transmitting indication information, applicable to a network device, and corresponding to the embodiment of the second aspect.

FIG. 8 is a schematic diagram of the apparatus for transmitting indication information of the embodiment the third aspect of this disclosure. As shown in FIG. 8, the apparatus 800 for transmitting indication information includes a second processor 801.

The second processor 801 controls the network device to perform the method for transmitting indication information described in the embodiment of the second aspect.

### Embodiment of a Fourth Aspect

The embodiment of this disclosure provides a communication system, including a network device and a terminal equipment.

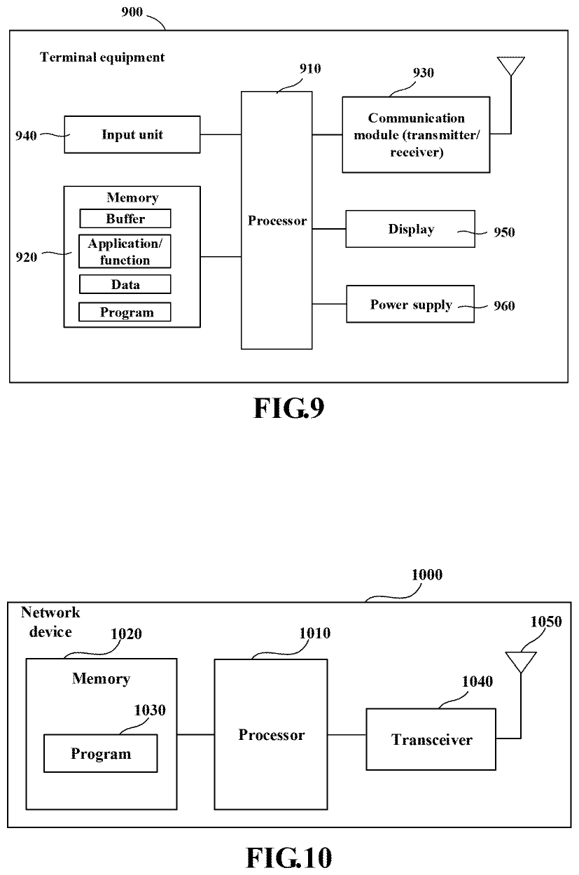

FIG. 9 is a schematic diagram of the terminal equipment of the embodiment of the fourth aspect of this disclosure. As shown in FIG. 9, the terminal equipment 900 (such as corresponding to the terminal equipment 102 in FIG. 1) may include a processor 910 and a memory 920, the memory 920 storing data and programs and being coupled to the processor 910. It should be noted that this figure is illustrative only, and other types of structures may also be used, so as to supplement or replace this structure and achieve a telecommunications function or other functions.

For example, the processor 910 may be configured to execute a program to carry out the method described in the embodiment of the first aspect.

As shown in FIG. 9, the terminal equipment 900 may further include a communication module 930, an input unit 940, a display 950, and a power supply 960, functions of the above components are similar to those in the prior art, and shall not be described herein any further. It should be noted that the terminal equipment 900 does not necessarily include all the parts shown in FIG. 9, and the above components are not necessary. Furthermore, the terminal equipment 900 may include parts not shown in FIG. 9, and the prior art may be referred to.

FIG. 10 is a schematic diagram of the network device of the embodiment of the fourth aspect. As shown in FIG. 10, the network device 1000 (such as corresponding to the network device 101 in FIG. 1) may include a processor 1010 (such as a central processing unit (CPU)) and a memory 1020, the memory 1020 being coupled to the processor 1010. Wherein, the memory 1020 may store various data, and furthermore, it may store a program 1030 for information processing, and execute the program 1030 under control of the processor 1010.

For example, the processor 1010 may be configured to execute a program to carry out the method described in the embodiment of the second aspect.

Furthermore, as shown in FIG. 10, the network device 1000 may include a transceiver 1040, and an antenna 1050, etc. Wherein, functions of the above components are similar to those in the prior art, and shall not be described herein any further. It should be noted that the network device 1000 does not necessarily include all the parts shown in FIG. 10, and furthermore, the network device 1000 may include parts not shown in FIG. 10, and the prior art may be referred to.

An embodiment of this disclosure provides a computer readable program code, which, when executed in a terminal equipment, will cause the terminal equipment to carry out the method described in the embodiment of the first.

An embodiment of this disclosure provides a computer readable medium, including a computer readable program code, which will cause a terminal equipment to carry out the method described in the embodiment of the first.

An embodiment of this disclosure provides a computer readable program code, which, when executed in a network device, will cause the network device to carry out the method described in the embodiment of the second aspect.

An embodiment of this disclosure provides a computer readable medium, including a computer readable program code, which will cause a network device to carry out the method described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 9 may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 12 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to the implementations including the above embodiments, following supplements are further disclosed.

1. An apparatus for receiving indication information, applicable to a terminal equipment, the apparatus comprising a first processor, the first processor controlling the terminal equipment to perform the following operations:
receiving a first configuration from a network device, the first configuration being used for configuring conditional handover;
receiving first downlink control information (DCI) from the network device in a first serving cell, the first DCI comprising first information and/or second information, wherein the first information is used to indicate dormancy or shutdown information related to A serving cells of the terminal equipment, and the second information is used to activate or deactivate cell discontinuous transmission or reception (Cell DTX/DRX) of B serving cells of the terminal equipment; where, A and B are positive integers; and
performing operations related to the conditional handover.

2. The apparatus according to supplement 1, wherein the first processor controls the terminal equipment to further perform the following operations:
receiving a second configuration and/or a third configuration from the network device, the second configuration being used to configure dormancy or shutdown of the A serving cells, and the third configuration being used to configure cell discontinuous transmission and/or cell discontinuous reception of the B serving cells,
wherein a block in the first DCI comprises at least one of a first bit, a second bit or a third bit,
the first bit, the second bit and the third bit each comprising at least one bit,
wherein the first bit is used to denote activation or deactivation of discontinuous transmission of a serving cell or a serving cell group corresponding to the block;
the second bit is used to denote activation or deactivation of discontinuous reception of a serving cell or a serving cell group corresponding to the block;
and the third bit is used to indicate dormancy or shutdown information of a serving cell or a serving cell group corresponding to the block,
wherein in the first DCI, in the block including the first bit, the second bit and the third bit,
the first bit is a most significant bit of the block, the second bit is a second most significant bit, and the third bit is a least significant bit; or
the third bit is a most significant bit of the block, the second bit is a second most significant bit, and the first bit is a least significant bit.

3. The apparatus according to supplement 1, wherein,
the terminal equipment receives a second configuration and/or a third configuration from the network device, the second configuration being used to configure dormancy or shutdown of the A serving cells, and the third configuration being used to configure cell discontinuous transmission and/or cell discontinuous reception of the B serving cells;
and a third serving cell or third serving cell group of the terminal equipment is included in both the A serving cells and the B serving cells, and the first information and the second information corresponding to the third serving cell or the third serving cell group are carried by one block.

4. The apparatus according to supplement 1, wherein,
the terminal equipment determines at least according to the first configuration that a sixth cell is a target cell, and performs conditional handover by taking the fourth serving cell as a source cell and the sixth cell as a target cell; and/or,
the terminal equipment does not monitor the first DCI from a second slot to a third slot; and/or,
the terminal equipment does not monitor the first DCI before the conditional handover operation is completed.

5. The apparatus according to supplement 1, wherein,
the terminal equipment further receives the third configuration from the network device, a ninth serving cell or a ninth serving cell group of the terminal equipment is at least included in the B serving cells, the third configuration includes a cell discontinuous transmission configuration and a cell discontinuous reception configuration of the ninth serving cell or the ninth serving cell group, and a second block in the first DCI used to carry the second information to which the ninth serving cell or the ninth serving cell group corresponds includes the first bit and the second bit; or,
the terminal equipment receives the third configuration, a ninth serving cell or a ninth serving cell group of the terminal equipment is at least included in the B serving cells, the third configuration includes a cell discontinuous transmission configuration and a cell discontinuous reception configuration of the ninth serving cell or the ninth serving cell group, and a second block in the first DCI used to carry the second information to which the ninth serving cell or the ninth serving cell group corresponds includes the first bit or the second bit;
wherein the first bit and the second bit respectively include one bit.

6. The apparatus according to supplement 5, wherein,
the terminal equipment further receives the second configuration from the network device, the second configuration being used to configure dormancy or shutdown of the A serving cells,
the ninth serving cell or the ninth serving cell group is also included in the A serving cells, and the first information corresponding to the ninth serving cell or the ninth serving cell group is carried by the first block of the first DCI.

7. The apparatus according to supplement 6, wherein,
the start bit position of the first block is determined by a first higher layer parameter,
and the start bit position of the second block is determined by a second higher layer parameter,
wherein the first higher layer parameter and the second higher layer parameter are carried by the fourth configuration; and/or
the second block includes a third bit, wherein the third bit includes at least one bit, or the third bit includes a bitmap.

8. The apparatus according to supplement 1, wherein the first DCI includes first information, wherein,
the first information is scrambled according to a first RNTI, the first RNTI being an RNTI related to conditional handover.

9. The apparatus according to supplement 8, wherein the first processor controls the terminal equipment to further perform the following operations:
receiving second DCI by the terminal equipment, the second DCI including second information, the second information being used to activate or deactivate cell discontinuous transmission or reception (Cell DTX/DRX) of the B serving cells or B1 serving cell groups of the terminal equipment; where, B and B1 are positive integers; and
scrambling the second DCI according to a second RNTI.

10. The apparatus according to supplement 8, wherein the first processor controls the terminal equipment to further perform the following operations:
receiving the first RNTI, the first RNTI being an RNTI related to conditional handover; and/or,
receiving the second RNTI, the second RNTI being a radio network temporary identifier (RNTI) of cell discontinuous transmission or reception.

1. An indication information receiving apparatus, applied to a terminal device, where the apparatus comprising:
a receiver configured to:
receive a first configuration from a network device, the first configuration being used to configure a conditional handover, and;
receive, in a first serving cell, first downlink control information (DCI) from the network device, the first DCI comprising first information which is used to indicate a conditional handover condition related to a first number of primary serving cell of the terminal device, and/or second information which is used to activate or deactivate cell discontinuous transmission or reception (Cell DTX/DRX) of a second number of serving cell of the terminal device, the first number and the second number being positive integers; and
a processor configured to perform an operation related to the conditional handover.

2. The apparatus according to claim 1, wherein
the operation comprises at least one of following operations:
performing the conditional handover according to the first configuration; or
cancelling the conditional handover related to the first configuration.

3. The apparatus of claim 1, wherein:
the conditional handover is used for energy saving of the network device; and
the first configuration comprises at least one of following:
a measurement object,
reporting configuration,
a measurement identity (Meas),
a conditional handover reconfiguration identifier (CondReconfigure Id), or
a measurement event.

4. The apparatus according to claim 1, wherein the first DCI is group-common DCI.

5. The apparatus according to claim 1, wherein the receiver is further configured to receive, from the network device, a fourth configuration being used to configure information related to reception of the first DCI.

6. The apparatus of claim 1, wherein the first number is equal to or not equal to the second number.

7. The apparatus according to claim 1, wherein the first information is carried by one or more first blocks in the first DCI, and/or the second information is carried by one or more second blocks in the first DCI.

8. The apparatus of claim 7, wherein:
a first correspondence between the one or more first blocks correspond and the first number of primary serving cells and a second correspondence between the one or more second blocks and the second number of serving cells are configured by the network device.

9. The apparatus according to claim 1, wherein
the first information is carried by A1 block in the first DCI, the second information is carried by B1 block in the first DCI, A1 and B1 are positive integers, A1 is less than or equal to the first number, and B1 is less than or equal to the second number.

10. The apparatus of claim 9, wherein:
the first number of primary serving cells are A1 serving cell groups, and/or the second number of serving cells are B1 serving cell groups,
the A1 blocks are in first one-to-one correspondence with the A1 serving cell groups, and/or the B1 blocks are in second one to one correspondence with the B1 serving cell groups, and the first one-to-one correspondence and the second one-to-one correspondence are configured by the network device.

11. The apparatus of claim 7, wherein a starting bit position of the one or more first blocks is determined by a higher layer parameter.

12. The apparatus of claim 7, wherein the one or more first blocks comprises at least one bit, or a bitmap.

13. The apparatus according to claim 1, wherein
the receiver is further configured to receive, from the network device, a second configuration and/or a third configuration, the second configuration being used to configure a handover event of the first primary serving cells, and the third configuration being used to configure cell discontinuous transmission and/or cell discontinuous reception of the second number of serving cells.

14. The apparatus of claim 13, wherein
a block in the first DCI comprises at least one of a first bit, a second bit, and a third bit.

15. The apparatus of claim 14, wherein
the first bit is used to indicate activation or deactivation for discontinuous transmission of a serving cell or a serving cell group corresponding to the block,
the second bit is used to indicate activation or deactivation of discontinuous reception of a serving cell or a serving cell group corresponding to the block, and
the third bit is used to indicate a conditional handover related with energy-saving of network device of a serving cell or a serving cell group corresponding to the block.

16. The apparatus of claim 15, wherein
the third bit comprises one bit;
the one bit is a first value when a serving cell or a serving cell group corresponding to the block is not shut down or is not dormant or shutdown or dormancy thereof is about to end;
the one bit is a second value when the serving cell or the serving cell group corresponding to the block is about to be shut down or dormant.

17. The apparatus according to claim 1, wherein
the receiver configured to receive, from the network device, the first information in a first slot of the first serving cell, the first information indicating to the terminal device that a fourth serving cell is about to be shut down or dormant; and
the processor is further configured to use the fourth serving cell as a source cell to perform the conditional handover.

18. The apparatus according to claim 1, wherein
the receiver configured to receive, from the network device, the first information in a first slot of the first serving cell, where the first information indicates to the terminal device that a fifth serving cell is not shut down or is not dormant, or that shutdown or dormancy of the fifth serving cell is about to end;
the processor is further configured to cancel the ongoing conditional handover using the fifth serving cell as a source cell.

19. An indication information transmitting apparatus, applied to a network device, where the apparatus comprising:
a processor configured to generate a first configuration; and
a transmitter configured to:
transmit the first configuration to a terminal device, the first configuration being used to configure a conditional handover, and;
transmit, in a first serving cell, first downlink control information (DCI) to the terminal device, the first DCI comprising first information which is used to indicate a conditional handover condition related to a first number of primary serving cell of the terminal device, and/or the second information which is used to activate or deactivate cell discontinuous transmission or reception (Cell DTX/DRX) of a second number of serving cell of the terminal device, the first number and the second number being positive integers.
